(19) United States
(12) Patent Application Publication
(10) Pub. No.: US 2009/0015969 A1
(43) Pub. Date: Jan. 15, 2009

(54) Magnetic thin film, magnetoresistance effect device and magnetic device using the same

(75) Inventors: Ryosuke Kainuma, Miyagi (JP); Koichiro Inomata, Miyagi (JP); Kiyohito Ishida, Miyagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN SCIENCE AND TECHNOLOGY AGENCY, Kawaguchi-shi (JP)

(21) Appl. No.: 10/589,283

(22) PCT Filed: Feb. 8, 2005
(86) PCT No.: PCT/JP05/02185

§ 371 Date: Aug. 14, 2006

(30) Foreign Application Priority Data
Feb. 13, 2004 (JP) 2004-037514

(51) Int. Cl. G11B 5/33; H01F 1/00

(52) U.S. Cl. 360/314; 360/324.2; 252/62.51 C; 252/62.55; 428/811.1; G9B/5.104; 977/934

(57) ABSTRACT

Magnetic thin film having high spin polarizability and a magnetoresistance effect device and a magnetic device using the same, provided with a substrate (2) and Co₂MGa₁₋ₓAlₓ thin film (3) formed on the substrate (2), the Co₂MGa₁₋ₓAlₓ thin film (3) has a L2₁ or B2 single phase structure, M of the thin film is either one or two or more of Ti, V, Mo, W, Cr, Mn, and Fe, an average valence electron concentration Z in M is 5.5≦Z≦7.5, and 0≦x≦0.7, shows ferromagnetism at room temperature, and can attain high spin polarizability. A buffer layer (4) may be inserted between the substrate (2) and the Co₂FeₓCr₁₋ₓAl thin film (3). The tunnel magnetoresistance effect device and the giant magnetoresistance effect device using this magnetic thin film can attain large TMR and GMR at room temperature under the low magnetic field.

### TECHNICAL FIELD

The present invention relates to a magnetic thin film of large spin polarizability, and a magnetoresistance effect device and a magnetic device using the same.

### BACKGROUND ART

In recent years, giant magnetoresistance (GMR) effect devices consisting of multi layered films of ferromagnetic layer/nonmagnetic metal layer, tunnel magnetoresistance effect devices and ferromagnetic spin tunnel junction (MTJ) devices consisting of ferromagnetic layer/insulating layer/ferromagnetic layer have been drawing attention as new magnetic field sensors and non-volatile random access magnetic memories (MRAM).

As GMR effect devices, the GMR effect devices of CIP (Current In Plane) structure type flowing electric current in a film plane and the GMR effect devices of CPP (Current Perpendicular to the Plane) structure type flowing electric current in the direction perpendicular to a film plane are known. The principle of GMR effect devices is spin dependent scattering in the interface between a magnetic and a nonmagnetic layers, and, in general, GMR is larger for the GMR effect devices of CPP structure than for the GMR effect devices of CIP structure.

As such GMR effect devices, the spin valve type is used which fixes a ferromagnetic layer spin by having an antiferromagnetic layer approaching one of ferromagnetic layers. In case of spin valve type GMR effect devices of the CPP structure, since the electric resistance ratio of the antiferromagnetic layer is about 200 μΩ·cm, larger by about two orders than the GMR film, the GMR effect is diluted, and hence the value of magnetic resistance of the spin valve type GMR effect device of CPP structure is as small as 1% or lower. Therefore, though GMR effect devices of CIP structure have already been practically used for play back heads of hard discs, GMR effect devices of CPP structure have so far not been practically used.

On the other hand, tunnel magnetoresistance effect devices and MTJ can bring about so-called tunnel magnetoresistance (TMR) effect, such that the magnitudes of tunnel currents in the direction perpendicular to layer surface differ from each other by controlling magnetization of two ferromagnetic layers mutually parallel or antiparallel by external magnetic field (Refer to Reference 1.). This TMR depends upon spin polarizability P at the interface of the ferromagnet and the insulator that are used, and is known to be expressed in general by Equation (1), assuming the spin polarizabilities of two ferromagnets as P1 and P2, respectively.

TMR=2P₁P₂/(1−P₁P₂) (1),

where spin polarizability P of a ferromagnet has a value 0<P≦1.

The highest TMR at room temperature so far obtained is about 50% in case of CoFe alloy of P˜0.5. TMR devices are presently expected for application to magnetic heads of hard discs and non-volatile random access magnetic memories (MRAM). In MRAM, “1” and “0” are recorded by controlling two magnetic layers mutually parallel and antiparallel which make up each MTJ device by arranging MTJ devices in matrix, and applying magnetic field by flowing electric current in the interconnection provided separately. The readout is conducted utilizing TMR effect. However, MRAM has such a problem to be solved that, when a device size is made small for high density, the noise increases accompanying the non-homogeneity of devices, thereby the TMR value is currently insufficient. Therefore, the devices with larger TMR need to be developed.

As is seen from Equation (1) above, infinitely large TMR is expected by using a magnet of P=1. A magnet of P=1 is called a half metal. Such oxides as Fe₃O₄, CrO₂, (La—Sr)MnO₃, Th₂MnO₇, and Sr₂FeMoO₆, such half Heusler alloy as NiMnSb, and such full Heusler alloys having L2₁ structure as Co₂MnGe, CO₂MnSi, and Co₂CrAl are so far known as half metals by band structure calculation. For example, it was reported that such full Heusler alloys having L2₁ structure as Co₂MnGe could be manufactured by heating a substrate at about 300° C. and further making its film thickness 25 nm or more in general (Refer to Reference 2.).

It was reported recently that Co₂Fe_{0.4}Cr_{0.6}Al in which a part of Cr as a component element of a half metal Co₂CrAl was substituted with Fe was a half metal of L2₁ type according to theoretical calculation of a band structure (Refer to Reference 3.). A tunnel junction using said thin film was also prepared, TMR of about 16% at room temperature was reported (Refer to reference 4.). It was also reported that, for magnetization characteristics and half metal characteristics of Heusler compounds, these characteristics are summarized by total valence electrons Z of component elements (Refer to reference 5.).

Reference 1: T. Miyazaki and N. Tezuka, “Spin polarized tunneling in ferromagnet/insulator/ferromagnet junctions”, 1995, J. Magn. Magn. Mater., L39, p. 1231

Reference 2: T. Ambrose, J. J. Crebs and G. A. Prinz, “Magnetic properties of single crystal Co₂MnGe Heusler alloy films”, 2000, Appl. Phys. Lett., Vol. 87, p. 5463

Reference 3: T. Block, C. Felser, and J. Windeln, “Spin Polarized Tunneling at Room Temperature in a Heusler Compound-a non-oxide Materials with a Large Negative Magnetoresistance Effect in Low Magnetic Fields”, Apr. 28, 2002, Intermag Digest, EE01

Reference 4: K. Inomata, S. Okamura, R. Goto, and N. Tezuka, “Large tunneling magnetoresistance at room temperature using a Heusler alloy with B 2 strucutre”, 2003, Jpn. J. Appl. Phys., Vol. 42, PL419

Reference 5: I. Galanakis and P. H. Dederichs, “Slater-Pauling behavior and origin of the half-metallicity of the full-Heusler alloys”, 2002, The American Physical Society, PHYSICAL REVIEW B, Vol. 66, pp. 174429-1-174429-9

Although giant magnetoresistance effect devices of CIP structure practically used at present for play back heads of conventional hard discs are being made microfabrication for high record density, the insufficiency of signal voltage has been predicted as a device is micro-fabricated. The higher quality of giant magnetoresistance effect devices of CPP structure is demanded instead of giant magnetoresistance effect devices of CIP structure, which so far has not been realized.

Except for the above-mentioned half metal Co₂CrAl, half metal thin films have been fabricated, but it needs for it to heat a substrate at 300° C. or higher, or to anneal at 300° C. or higher after film forming at room temperature. However, there have been no reports that the so far fabricated thin film is a half metal. The fabrication of tunnel junction devices using these half metals has been partly attempted, but TMR at room temperature is in all cases unexpectedly low, such that its maximum value is at most between 10 and 20% of the case using Fe₃O₄.

As has been seen, the conventional half metal thin film requires the substrate heating or thermal treatment to attain its structure, and surface roughness increase or oxidation thereby may be considered as one of the causes for no large TMR attained.

On the other hand, the thin film differs from bulk materials in that it may not show half metal characteristics on the surface, and the half metal characteristics is sensitive to the composition and the regularity of atomic alignments. The tunnel junction in particular has difficulty to attain the half metal electronic state at its interface. This is regarded as the cause for large TMR not attained. From the above, there remains a problem that the fabrication of half metal thin film is actually very difficult, and the half metal thin film good enough to be used for various magnetoresistance effect devices has so far not been obtained.

Co₂Fe_{0.4}Cr_{0.6}Al thin film, which are predicted to be a half metal from theoretical calculation of band structure, and the tunnel junction using said thin film has been fabricated, and TMR was obtained. However, since the CoAl compound of B2 structure is extremely stable at Co₂CrAl side where x=0, there is such a problem that CoAl of B2 structure and CoCr of A2 structure tend to cause two phase separation, thereby such a single phase alloy as Co₂Fe_{0.4}Cr_{0.6}Al thin film which is expected to have half metal characteristics is hard to obtain.

### DISCLOSURE OF THE INVENTION

In view of the problems mentioned above, it is an object of the present invention to provide magnetic thin film of high spin polarizability and a magnetoresistance effect device and a magnetic device using the same.

The present inventors completed the present invention by finding that, as a result of fabrication of Co₂MGa_{1-X}Alₓ thin film, taking into consideration that Ga is an element having valence electrons equal to Al, and CoGa is not as stable as CoAl, this film is ferromagnetic at room temperature, and either L2₁ or B2 single phase structure can be prepared by not heating a substrate, or making film at 500° C. or lower, and further by annealing this thin film at 500° C. or lower.

In order to achieve the objects mentioned above, a magnetic thin film of the present invention is characterized in that it comprises a substrate, and Co₂MGa₁₋ₓAlₓ thin film formed on said substrate, and said Co₂MGa₁₋ₓAlₓ thin film has L2₁ or B2 single phase structure, M of the thin film consists either of Mo, W, or Cr, or of two or more of Ti, V, Mo, W, Cr, Mn, and Fe, and an average valence electron concentration Z of M is 5.5≦Z≦7.5, and x is 0≦x≦0.7.

The substrate may be such that said Co₂MGa₁₋ₓAlₓ thin film is formed thereon by heating at 500° C. or lower including non-heating, or said formed thin film is further annealed at 500° C. or lower. Said substrate may be either one of thermally oxidized Si, glass, MgO single crystal, GaAs single crystal, or Al₂O₃ single crystal. A buffer layer may be provided between the substrate and Co₂MGa₁₋ₓAlₓ thin film. As this buffer layer, at least either one of Al, Cu, Cr, Fe, Nb, Ni, Ta, and NiFe may be used.

According to this constitution, Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film or merely Co₂MGa₁₋ₓAlₓ thin film), which is ferromagnetic at room temperature, and a half metal having high spin polarizability can be obtained.

A tunnel magnetoresistance effect device of the present invention is characterized to be made of Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film in which at least one of ferromagnetic layers has L2₁ or B2 single phase structure in the tunnel magnetoresistance effect device having a plurality of ferromagnetic layers on a substrate.

In said constitution, the ferromagnetic layer preferably consists of a fixed layer and a free layer, and the free layer is the Co₂MGa₁₋ₓAlₓ magnetic thin film having L2₁ or B2 single phase structure. Said substrate may be such that Co₂MGa₁₋ₓAlₓ magnetic thin film is formed thereon by heating at 500° C. or lower including non-heating, or by further annealing said formed thin film at 500° C. or lower. Said substrate may be either one of thermally oxidized Si, glass, MgO single crystal, GaAs single crystal, or Al₂O₃ single crystal. A buffer layer may be provided between the substrate and Co₂MGa₁₋ₓAlₓ thin film. Said buffer layer may be made of at least either one of Al, Cu, Cr, Fe, Nb, Ni, Ta, or NiFe.

According to the constitution described above, a tunnel magnetoresistance effect device of large TMR in the low external magnetic field at room temperature can be obtained.

A giant magnetoresistance effect device of the present invention is characterized to be made of Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film in which at least one of ferromagnetic layers has L2₁ or B2 single phase structure in the giant magnetoresistance effect device having a plurality of ferromagnetic layers on a substrate, and to have a structure in which electric current flows in the direction perpendicular to the film surface.

Said ferromagnetic layer preferably consists of a fixed layer and a free layer, and the free layer is preferably made of Co₂MGa₁₋ₓAlₓ (0≦x≦0.7) magnetic thin film having L2₁ or B2 single phase structure. Said substrate may be such that Co₂MGa₁₋ₓAlₓ thin film is formed thereon by heating at 500° C. or lower including non-heating, or by further annealing said formed thin film at 500° C. or lower. A buffer layer may be provided between the substrate and Co₂MGa₁₋ₓAlₓ thin film. Said substrate may be either one of thermally oxidized Si, glass, MgO single crystal, GaAs single crystal, or Al₂O₃ single crystal. Said buffer layer may be made of at least either one of Al, Cu, Cr, Fe, Nb, Ni, Ta, or NiFe.

According to the constitution described above, a giant magnetoresistance effect device of large GMR in the low external magnetic field at room temperature can be obtained.

A magnetic device of the present invention is characterized in that the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film having L2₁ or B₂ single phase structure is formed on a substrate. In this case, either a tunnel or a giant magnetoresistance effect device may be used in which a free layer is made of the above-mentioned Co₂MGa₁₋ₓAlₓ (0≦x≦0.7) magnetic thin film.

A tunnel or a giant magnetoresistance effect device is preferably fabricated by heating a substrate at 500° C. or lower including non-heating to form Co₂MGa₁₋ₓAlₓ thin film thereon, or by further annealing said formed thin film at 500° C. or lower. A tunnel or a giant magnetoresistance effect device may be used in which a buffer layer is provided between the substrate and Co₂MGa₁₋ₓAlₓ (0≦x≦0.7) thin film. A tunnel or a giant magnetoresistance effect device may be used in which said substrate is either one of thermally oxidized Si, glass, MgO single crystal, GaAs single crystal, or Al₂O₃ single crystal. A tunnel or a giant magnetoresistance effect device may be used in which at least either one of Al, Cu, Cr, Fe, Nb, Ni, Ta, or NiFe is used as the buffer layer.

According to the constitution described above, a magnetic device using a magnetoresistance effect device of large TMR or GMR in the low external magnetic field at room temperature can be obtained.

A magnetic head and a magnetic recording device of the present invention is characterized in that the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film having L2₁ or B2 single phase structure is formed on a substrate.

In the constitution described above, a tunnel or a giant magnetoresistance effect device is preferably used in which a free layer is said Co₂MGa₁₋ₓAlₓ (where 0≦x≦0.7) magnetic thin film. A tunnel or a giant magnetoresistance effect device may be used in which Co₂MGa₁₋ₓAlₓ thin film is formed by heating a substrate at 500° C. or lower including non-heating, or by further annealing said formed thin film at 500° C. or lower. A tunnel or a giant magnetoresistance effect device may be used in which a buffer layer is provided between the substrate and Co₂MGa₁₋ₓAlₓ thin film. A tunnel or a giant magnetoresistance effect device may be used in which the substrate is either one of thermally oxidized Si, glass, MgO single crystal, GaAs single crystal, or Al₂O₃ single crystal. A tunnel or a giant magnetoresistance effect device may be used in which the buffer layer is at least either one of Al, Cu, Cr, Fe, Nb, Ni, Ta, or NiFe.

According to the constitution described above, a magnetic head and a magnetic recording device of large capacity and high speed can be obtained by using a magnetoresistance effect device of large TMR or GMR in the low external magnetic field at room temperature.

### BRIEF DESCRIPTION OF THE DRAWINGS

FIG. 1 is a cross-sectional view illustrating magnetic thin film in accordance with the first embodiment of the present invention.

FIG. 2 is a cross-sectional view illustrating a modified version of magnetic thin film in accordance with said first embodiment.

FIG. 3 is a view diagrammatically illustrating the structure of Co₂MGa₁₋ₓAlₓ used as a magnetic thin film in accordance with said first embodiment.

FIG. 4 is a view illustrating the cross section of a magnetoresistance effect device using magnetic thin film in accordance with the second embodiment of the present invention.

FIG. 5 is a view illustrating the cross section of a modified version of a magnetoresistance effect device using magnetic thin film in accordance with said second embodiment.

FIG. 6 is a view illustrating the cross section of a modified version of a magnetoresistance effect device using magnetic thin film in accordance with said second embodiment.

FIG. 7 is a view illustrating the cross section of a magnetoresistance effect device using magnetic thin film in accordance with the third embodiment of the present invention.

FIG. 8 is a view illustrating the cross section of a modified version of a magnetoresistance effect device using magnetic thin film in accordance with said third embodiment.

FIG. 9 is a view diagrammatically illustrating the resistance when the external magnetic field is applied to a magnetoresistance effect device using magnetic thin film of the present invention.

FIG. 10 is a view illustrating electron beam diffraction of [01-1] incoming radiation of Co₂CrGa alloy prepared in Example 1.

FIG. 11 is a view illustrating the magnetic field dependency of the resistance of a tunnel magnetoresistance effect device of Example 2.

FIG. 12 is a view illustrating the magnetic field dependency of the resistance of a tunnel magnetoresistance effect device of Example 3.

### BEST MODES FOR CARRYING OUT THE INVENTION

Hereinafter, forms of implementations of the present invention will be described in detail to help better understanding with reference to the accompanying drawings. Here, the various Examples illustrated in the accompanying drawings are in no way intended to specify or limit the present invention, but only to facilitate explanation and understanding of the present invention.

The present invention will be explained in detail below based on the forms of implementations illustrated in the figures. In each figure, identical marks and symbols are used for identical or corresponding parts.

The first embodiment of the magnetic thin film of the present invention will be explained first.

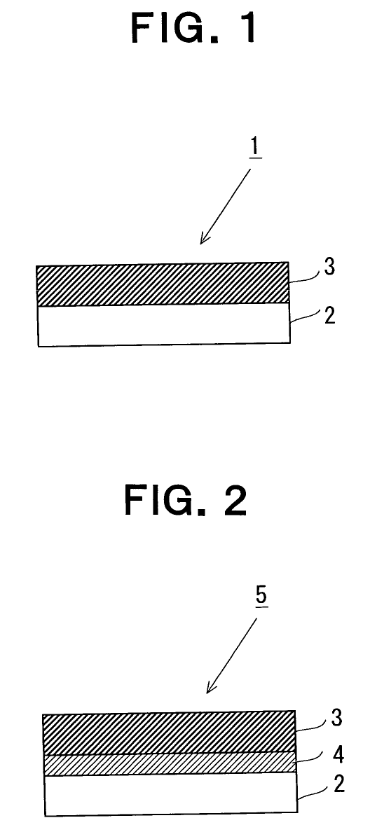

FIG. 1 is a cross-sectional view illustrating a magnetic thin film in accordance with the first embodiment of the present invention. As shown in FIG. 1, the magnetic thin film 1 of the present invention is provided with Co₂MGa_{1-X}Al_{X} thin film 3 on a substrate 2 at room temperature. In the Co₂MGa₁₋ₓAlₓ thin film 3, M consists either of Mo, W, or Cr, or of two or more of Ti, V, Mo, W, Cr, Mn, and Fe, and an average valence electron concentration Z of M is 5.5≦Z≦7.5, and x is 0≦x≦0.7, where said valence electron concentration Z of an element in M is defined as Z_{Ti}=4, Z_{V}=5, Z_{Cr}=Z_{Mo}=Z_{W}=6, Z_{Mn}=7, and Z_{Fe}=8 for the above-mentioned elements Ti, V, Mo, W, Cr, Mn, and Fe, respectively. In case that M is either Cr, Mo, or W, the average valence electron concentration Z is 6, and hence satisfies 5.5≦Z≦7.5 above.

The average valence electron concentration Z in case that M is two species will be explained. Its composition is assumed as M=M₁ₐM₂₁₋ₐ. M₁ and M₂ are metals selected from the above-mentioned metals M, and their compositions are a for M₁ and 1-a for M₂. The valence electron concentration Z of M₁ and M₂ are Z_{M1} and Z_{M2}, respectively. Said average valence electron concentration Z of M₁ₐM₂₁₋ₐ can be calculated by Z=a×Z_{M1}+(1-a)×Z_{M2}, and the composition of M may be determined so that Z comes within the range of 5.5≦Z≦7.5.

In case that M is two or more species, M may be selected so that the average valence electron concentration Z similarly satisfies 5.5≦Z≦7.5 from its composition and valence electron concentrations Z. The Co₂MGa₁₋ₓAlₓ thin film 3 is ferromagnetic at room temperature, has the electrical resistivity of about 200 μΩ·cm, and has L2₁ or B2 single phase structure without heating the substrate. The film thickness of Co₂MGa₁₋ₓAlₓ thin film 3 on the substrate 2 may be 1 nm or more and 1 μm or less.

FIG. 2 is a cross-sectional view illustrating a modified version of magnetic thin film in accordance with the first embodiment of the present invention. As shown in FIG. 2, the magnetic thin film 5 of the present invention has additionally a buffer layer 4 inserted between the substrate 2 and Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 in the structure of the magnetic thin film 1 of FIG. 1. By inserting the buffer layer 4, the crystal quality of Co₂MGa₁₋ₓAlₓ (where 0≦x≦1) thin film 3 on the substrate 1 can be further improved.

The substrate 2 used for said magnetic thin films 1 and 5 may be a thermally oxidized Si, a polycrystal of glass or others, or a single crystal of MgO, Al₂O₃, or GaAs or others. As the buffer layer 4, Al, Cu, Cr, Fe, Nb, Ni, Ta, or NiFe may be used.

The film thickness of said Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 may be 1 nm or more and 1 μm or less. With said film thickness less than 1 nm, it is practically difficult to obtain L2₁ or B2 single phase structure as described below, and with said film thickness over 1 μm, application such as a spin injection device becomes difficult, and these conditions are not preferred.

The function of the magnetic thin film used in the first embodiment of the constitution described above will be explained next.

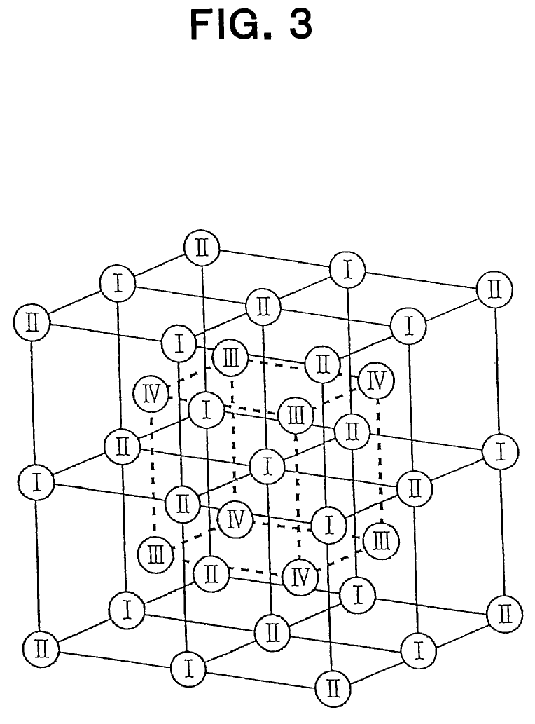

FIG. 3 is a view diagrammatically illustrating the structure of Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) used as the magnetic thin film of said first embodiment. The structure shown in the figure is that eight times as large (twice by a lattice constant) as a common unit lattice of bcc (body-centered cubic lattice).

In the L2₁ structure of Co₂MGa₁₋ₓAlₓ M is arranged at the position I of FIG. 3 (where M consists either of Mo, W, or Cr, or of two or more of Ti, V, Mo, W, Cr, Mn, and Fe) so that the composition is such that the average valence electron concentration Z is 5.5≦Z≦7.5, Ga and Al are arranged at the position II so that the relative composition is Ga₁₋ₓAlₓ (0≦x≦0.7), and Co is arranged at the positions III and IV.

In the B2 single phase structure of Co₂MGa₁₋ₓAlₓ, M, Ga, and Al are irregularly arranged at the positions I and II of FIG. 3 (where M consists either of Mo, W, or Cr, or of two or more of Ti, V, Mo, W, Cr, Mn, and Fe), and Co is arranged at the positions III and IV. In this case, the relative composition of M, Fe, and Cr is so adjusted as to be M₁Ga₁₋ₓAlₓ (where 0≦x≦0.7).

The magnetic properties of the magnetic thin films 1 and 5 used in the first embodiment of the above-described constitution will be explained next. The Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 of the constitution as mentioned above is ferromagnetic at room temperature, and the Co₂MGa₁₋ₓAlₓ thin film of L2₁ or B2 single phase structure is obtained without heating the substrate.

Further, the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 of the constitution as mentioned above can obtain L2₁ or B2 single phase structure even with a very thin film of the film thickness as thin as several nm. The B2 structure of the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film is similar to L2₁ structure, but their difference is that said M and Ga (Al) atoms are regularly arranged in L2₁ structure, whereas they are irregularly arranged in the B2 structure. These differences can be measured by X-ray and electron beam diffractions.

The reason why the average valence electron concentration Z is set as 5.5≦M≦7.5 for said Co₂MGa₁₋ₓAlₓ thin film 3 will be explained next. If Z is less than 5.5, the Currie temperature of the thin film becomes lower than 100° C., and a large TMR can not be attained at room temperature. On the other hand, if Z exceeds 7.5, the half metal characteristics of the thin film disappears, and, for example, large GMR or TMR can not be attained for a giant magnetoresistance effect device and a tunnel magnetoresistance effect devices both having CPP structures.

The second embodiment is shown next for the magnetoresistance effect device using the magnetic thin film of the present invention .

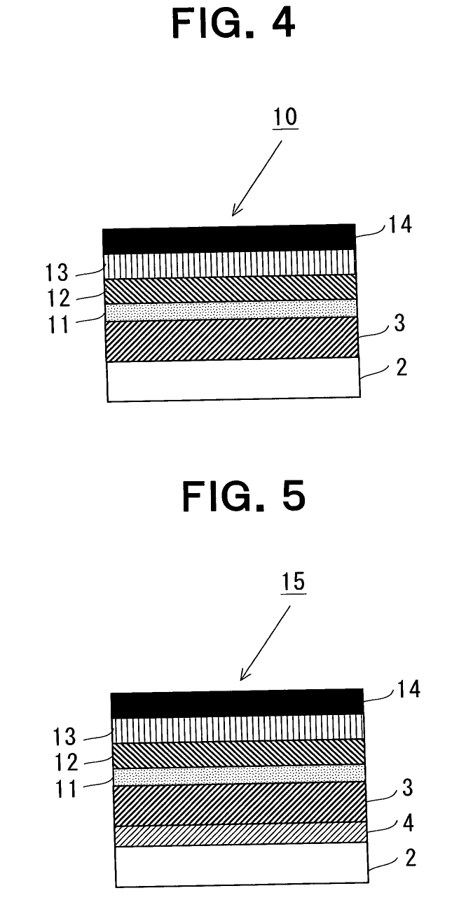

FIG. 4 is a view illustrating the cross section of a magnetoresistance effect device using magnetic thin film in accordance with the second embodiment of the present invention. FIG. 4 shows the case of a tunnel magnetoresistance effect device. As shown in this figure, the tunnel magnetoresistance effect device 10 is provided, for example, with the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 on a substrate 2, and has a sequentially layered structure with an insulation layer 11 as a tunnel layer, a ferromagnetic layer 12, and an antiferromagnetic layer 13. The antiferromagnetic layer 13 is used to fix a spin of the ferromagnetic layer 12 for a so-called spin valve type structure. In said structure, the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 is called a free layer, and the ferromagnetic layer 12 is called a pin layer. Here, the ferromagnetic layer 12 may have either a single layer structure or a plural layer structure. Al₂O₃ or AlOₓ as an oxide of Al can be used as the insulation layer 11, CoFe, NiFe, or a combination film of CoFe and NiFe and others can be used as the ferromagnetic layer 12, and IrMn and others can be used as the antiferromagnetic layer 13.

Further, a non-magnetic electrode layer 14 is preferably deposited as a protective film on the antiferromagnetic layer 13 of the tunnel magnetoresistance effect device 10 of the present invention.

FIG. 5 is a view illustrating the cross section of a modified version of a magnetoresistance effect device using magnetic thin film in accordance with the second embodiment of the present invention. A tunnel magnetoresistance effect device 15 as a magnetoresistance effect device using magnetic thin film of the present invention is provided with a buffer layer 4 and the Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 on the substrate 2, and has a sequentially layered structure with the insulation layer 11 as the tunnel layer, the ferromagnetic layer 12, the antiferromagnetic layer 13, and a non-magnetic electrode layer 14 as a protective layer. The difference of FIG. 5 from FIG. 4 in the structure is that the buffer layer 4 is provided to the structure of FIG. 4. All other structures are same as FIG. 4.

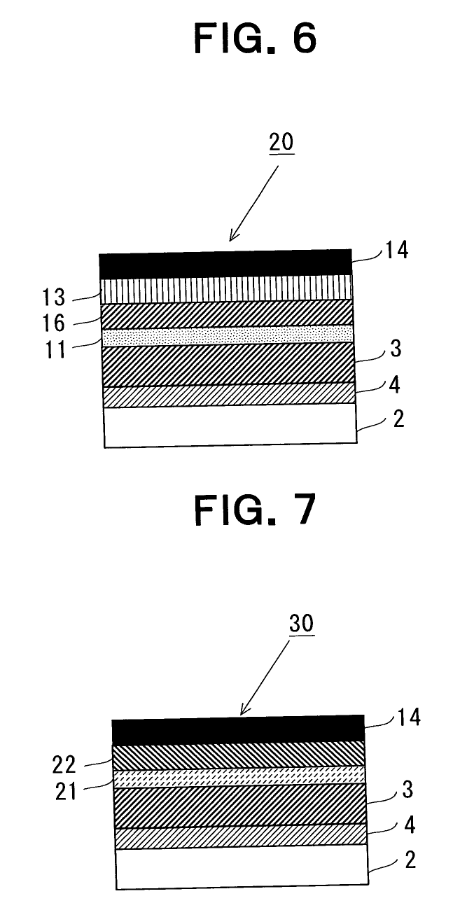

FIG. 6 is a view illustrating the cross section of a modified version of a magnetoresistance effect device using magnetic thin film in accordance with the second embodiment of the present invention. A tunnel magnetoresistance effect device 20 as the magnetoresistance effect device using magnetic thin film of the present invention is provided with a buffer layer 4 and Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 16, the antiferromagnetic layer 13, and the non-magnetic electrode layer 14 as the protective layer on the substrate 2 in the sequentially layered structure. The difference of FIG. 6 from FIG. 5 in the structure is that the magnetic thin film of the present invention Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 16 is used also for the ferromagnetic layer 12 as the pin layer of FIG. 4. All other structures are same as FIG. 5.

When a voltage is applied to the tunnel magnetoresistance effect devices 10, 15, and 20, it is applied between Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 or a buffer layer 4 and the electrode layer 14. As the method to flow electric current from the buffer layer 4 to the electrode layer 14, the CPP structure to flow the electric current in the direction perpendicular to the film surface may be employed.

Here, the substrate 2 used for said tunnel magnetoresistance effect devices 10, 15, and 20 may be such a thermally oxidized Si, polycrystal such as glass, or such a single crystal as MgO, Al₂O₃, and GaAs. As the buffer layer 4, Al, Cu, Cr, Fe, Nb, Ni, Ta, NiFe, or others may be used. The film thickness of said Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 may be 1 nm or more and 1 μm or less. If said film thickness is less than 1 nm, then it becomes difficult to practically obtain L2₁ or B2 single phase structure, and if it exceeds 1 μm, its application as the tunnel magnetoresistance effect device becomes difficult, and both cases are not preferable. The tunnel magnetoresistance effect devices 10, 15, and 20 of the present invention constituted as described above can be fabricated by such an ordinary thin film forming method as a sputtering method, a vapor deposition method, a laser ablation method, and an MBE method, and a masking process to form an electrode of the pre-determined shape or others.

The operation of tunnel magnetoresistance effect devices 10 and 15 as magnetoresistance effect devices using magnetic thin film of the present invention will be explained next.

In case of magnetoresistance effect devices 10 and 15 using magnetic thin film of the present invention, only the spin of the ferromagnetic layer Co₂MGa₁₋ₓAlₓ as the other free layer (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 is inverted, since two ferromagnetic layers 3 and 12 are used, an antiferromagnetic layer 13 approaches one of them, and a spin valve type to fix the spin of the approaching ferromagnetic layer 12 (pin layer) is used. Therefore, the parallel or the antiparallel state of spins of Co₂MGa₁₋ₓAlₓ as a free layer (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 can be attained easily, since spins are fixed in one direction for magnetization of the ferromagnetic layer 12 by spin valve effect by the exchange interaction with the antiferromagnetic layer 13. In this case, the antimagnetic field is small so that magnetic inversion can be caused by as small magnetic field, since magnetization of Co₂MGa₁₋ₓAlₓ as a free layer (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 is small. Therefore, the magnetoresistance effect devices 10 and 15 of the present invention are suitable to such magnetic devices requiring magnetic inversion by low power as MRAM.

The operation of tunnel magnetoresistance effect device 20 as a magnetoresistance effect device using magnetic thin film of the present invention will be explained next.

Since the tunnel magnetoresistance effect device 20 uses the same Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) as the ferromagnetic Co₂MGa₁₋ₓAlₓ as the free layer for the ferromagnetic layer 16 of the pin layer, the denominator of the equation (1) mentioned above becomes smaller, and further TMR of the tunnel magnetoresistance effect device of the present invention becomes larger. Therefore, the tunnel magnetoresistance effect device 20 of the present invention is suitable to such magnetic devices requiring magnetic inversion by low power as MRAM.

The third embodiment of the magnetoresistance effect device using magnetic thin film of the present invention will be explained next.

FIG. 7 is a view illustrating the cross section of a magnetoresistance effect device using magnetic thin film in accordance with the third embodiment of the present invention. The magnetoresistance effect device using magnetic thin film of the present invention shows the case of a giant magnetoresistance effect device. As is shown in the figure, the giant magnetoresistance effect device 30 is provided with a buffer layer 4 and Co₂MGa₁₋ₓAlₓ of the present invention as a ferromagnetic thin film 3 (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.), a non-magnetic metal layer 21, a ferromagnetic layer 22, and a non-magnetic electrode layer 14 as a protective layer on a substrate 2 in the sequentially layered structure.

Here, a voltage is applied between the buffer layer 4 and the electrode layer 14 of the giant magnetoresistance effect device. The external magnetic field is also applied in parallel in a film plane. The method to flow electric current from the buffer layer 4 to the electrode layer 14 may be both CIP structure of the type to flow electric current in a film plane and CPP structure of the type to flow electric current in the direction perpendicular to a film plane.

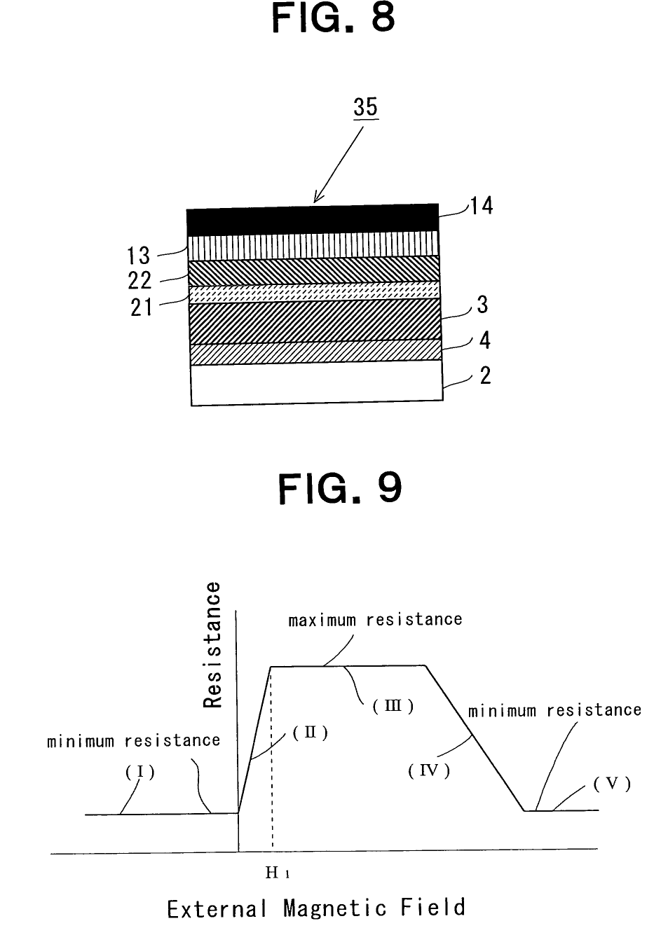

FIG. 8 is a view illustrating the cross section of a modified version of a magnetoresistance effect device using magnetic thin film in accordance with said third embodiment of the present invention. The difference of the giant magnetoresistance effect device 35 of the present invention from the giant magnetoresistance effect device 30 as shown in FIG. 7 is that an antiferromagnetic layer 13 is provided between the ferromagnetic layer 22 and the electrode layer 14 to employ a giant magnetoresistance effect device of a spin valve type. Other structures are same as that shown in FIG. 7 so the explanation is omitted. The antiferromagnetic layer 13 has a function to fix the spin of the ferromagnetic layer 22 as a pin layer in the vicinity. A voltage is applied between the buffer layer 4 and the electrode layer 14 of the giant magnetoresistance effect devices 30 and 35. The external magnetic field is also applied in parallel in a film plane. The method to flow electric current from the buffer layer 4 to the electrode layer 14 may be both CIP structure of the type to flow electric current in a film plane and CPP structure of the type to flow electric current in the direction perpendicular to a film plane.

As the substrate 2 of said giant magnetoresistance effect devices 30 and 35, such a thermally oxidized Si, polycrystal such as glass and others, or further such a single crystal as MgO, Al₂O₃, GaAs and others may be used. As the buffer layer 4, Al, Cu, Cr, Fe, Nb, Ni, Ta, NiFe, or others may be used. As the non-magnetic metal layer 21, Cu, Al, or others may be used. As the ferromagnetic layer 22, either one of CoFe, NiFe, or Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film, or a complex film made of these materials may be used. As the antiferromagnetic layer 13, IrMn or others may be used.

The film thickness of said Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 may be 1 nm or more and 1 μm or less. If said film thickness is less than 1 nm, then it becomes difficult to practically obtain L2₁ or B2 single phase structure, and if it exceeds 1 μm, its application as a giant magnetoresistance effect device becomes difficult, and both cases are not preferable. The giant magnetoresistance effect devices 30 and 35 of the present invention constituted as described above can be fabricated by such an ordinary thin film forming method as a sputtering method, a vapor deposition method, a laser ablation method, and an MBE method, and a masking process to form an electrode of the pre-determined shape or others.

Since the ferromagnetic layer Co₂MGa₁₋ₓAlₓ of the giant magnetoresistance effect device 30 as the magnetoresistance effect device using the magnetic thin film of the present invention (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 is a half metal, its spin polarizability is large. Therefore, only one of the spins of said thin film 3 contributes the conductivity when the external magnetic field is applied. Consequently, very large magnetic resistance i.e. GMR can be obtained by the giant magnetoresistance effect device 30.

Next, in case of the giant magnetoresistance effect device 35 of a spin valve type as a magnetoresistance effect device using a magnetic thin film, the spin of the ferromagnetic layer 22 as the pin layer is fixed by an antiferromagnetic layer 13, and the spin of the Co₂MGa₁₋ₓAlₓ thin film 3 as the free layer (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) takes the parallel or the antiparallel state by applying the external magnetic field. Since only one of the spins of the half metal Co₂MGa₁₋ₓAlₓ thin film 3 (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) contributes the conductivity, the very large GMR can be obtained.

Next, the fourth embodiment of the magnetic device using the magnetoresistance effect device with magnetic thin film of the present invention is shown.

As shown in FIGS. 1-8, the various magnetoresistance effect devices using magnetic thin film of the present invention have very large TMR or GMR in low magnetic field at room temperature.

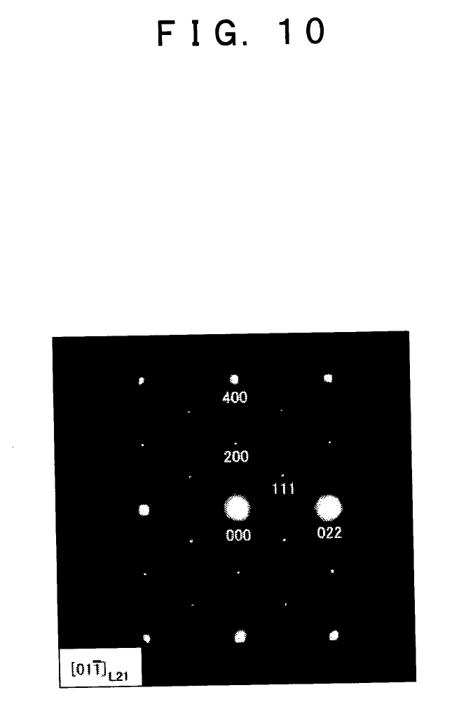

FIG. 9 is a view diagrammatically illustrating the resistance when the external magnetic field is applied to the tunnel or the giant magnetoresistance effect device as the magnetoresistance effect device using magnetic thin film of the present invention. The abscissa of the figure shows the external magnetic field applied to the magnetoresistance effect device using magnetic thin film of the present invention, and the ordinate shows the resistance. To the magnetoresistance effect device using magnetic thin film of the present invention is sufficiently applied the necessary voltage to obtain the giant or the tunnel magnetoresistance effect.

As is illustrated, the resistance of the magnetoresistance effect device using magnetic thin film of the present invention shows remarkable change by the external magnetic field. When the external magnetic field is applied from the region (I), it is reduced to zero, and it is further inverted and increased, then in the regions (II) and (III) the resistance changes from minimum to maximum. Here, the external magnetic field in the region (II) is defined as H₁.

When the external magnetic field is further increased, the resistance change is obtained from the region (III) to the region (V) via the region (IV). Thereby, the spins of the ferromagnetic layer 22 and the Co₂MGa₁₋ₓAlₓ as the free layer (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) thin film 3 become parallel in the magnetoresistance effect device using magnetic thin film of the present invention in the external magnetic field of the regions (I) and (V) to be the minimum resistance, and said spin becomes antiparallel in the region (III) to be the maximum resistance. As the Co₂MGa₁₋ₓAlₓ thin film 3, Co₂FeCrGa, for example, may be used.

The magnetoresistance change is expressed by the Equation (2) below when external magnetic field is applied, and the larger this value, the more preferable as the magnetoresistance change.

magnetoresistance change(%)=(maximum resistance−minimum resistance)/minimum resistance (2).

Thereby, the magnetoresistance effect device using magnetic thin film of the present invention can attain large magnetoresistance change, as shown in FIG. 9, by applying the magnetic field from zero to slightly larger than H₁, that is, low magnetic field.

As explained in FIG. 9, since the magnetoresistance effect device using magnetic thin film of the present invention shows large TMR or GMR at room temperature in low magnetic field, if used as a magnetoresistance sensor, a magnetic device of high sensitivity can be obtained. Since the magnetoresistance effect device using magnetic thin film of the present invention shows large TMR or GMR at room temperature in low magnetic field, it can be applied to the readout magnetic heads of high sensitivity, and various magnetic recording devices using said magnetic heads. MTJ devices, for example, which are the magnetoresistance effect devices using magnetic thin film of the present invention, are arranged in matrix, and are applied with the external magnetic field by flowing electric current in the separately provided interconnection. By controlling the magnetization of the ferromagnet as the free layer composing said MTJ devices to parallel or antiparallel by external magnetic field, “1” or “0” are recorded. Further by readout utilizing TMR effect, a magnetic device such as MRAM can be realized. Since GMR is large in a GMR device of CPP structure as the magnetoresistance effect devices of the present invention, large capacity of such magnetic device as a hard disc drive device (HDD) and MRAM can be realized.

### EXAMPLE 1

Examples of the present invention are explained hereafter.

As the magnetic thin film of the present invention Co₂MGa₁₋ₓAlₓ, Co₂CrGa was fabricated with Cr as M and composition x=0. In this case, the average valence electron concentration Z in M is 6.

The fabrication of the alloy Co₂CrGa as the material of the magnetic thin film of the present invention will be explained first. Co, Cr, and Ga of high purity were input into an arc melting apparatus by the composition ratio of 25%, 25%, and 50%, respectively, melted at 1100° C. for 24 hours, and hardened in ice water to fabricate Co₂CrGa alloy.

FIG. 10 is a view illustrating electron beam diffraction of [01-1] incoming radiation of Co₂CrGa alloy prepared in Example 1. The acceleration voltage of electron beam was 200 kV, and the numbers in the figure show diffraction from (200), (111), and (022) planes, respectively. As is obvious from the figure, both regular reflections from (200) and (111) planes appeared, and this alloy turned out to have L2₁ Heusler structure. Here, if this alloy has irregular body-centered cubic crystal, neither diffractions from (200) and (111) planes shown in the figure would not appear. Also, if it has B₂ structure, only the diffraction from the (200) plane would appear, and that from the (111) plane would not exist.

Co₂CrGa thin film onto the Ta thin films as the buffer layer 4 on the thermally oxidized Si substrate 2 or a Si substrate 2 was fabricated with changing the substrate temperature by using the high frequency sputtering apparatus in which target is said Co₂CrGa alloy. The structure of the thus fabricated Co₂CrGa magnetic thin film 3 at substrate temperature 500° C. or lower was L2₁ or B2 structure.

### EXAMPLE 2

The tunnel magnetoresistance effect device 15 of the spin valve type as shown in FIG. 5 was fabricated at room temperature. The tunnel magnetoresistance effect device 15 was fabricated by using a magnetron sputtering apparatus and a metal mask, with Ta as a buffer layer 4, and sequentially depositing Ta (10 nm)/Co₂CrGa (300 nm)/AlOₓ (1.6 nm)/Co₉₀Fe₁₀ (10 nm)/NiFe (2 nm)/IrMn (20 nm)/Ta (10 nm) onto the thermally oxidized Si substrate 2. The numbers in parentheses are respective film thicknesses. Ta is the buffer layer 4, Co₂CrGa thin film 3 is the ferromagnetic free layer, AlOₓ is the tunnel insulation layer 11, Co₉₀Fe₁₀ and NiFe are ferromagnets comprising a complex film made of pin layers of the ferromagnetic layer 12, IrMn is the antiferromagnetic layer 13 and has a role to fix the spins of the ferromagnetic layer 12 of Co₉₀Fe₁₀/NiFe. Ta on IrMn as the antiferromagnetic layer 13 is the protective layer 14.

The high frequency power of the magnetron was 100 W for respective film formations except for AlOₓ as said tunnel insulation film, and the high frequency power was 40 W for film formation of AlOₓ by plasma oxidation. The gas pressure of Ar for discharging was 1.8 Pa. The substrate temperature was 400° C., and Co₂CrGa thin film 3 in this case had L2₁ structure. Here, the uniaxial anisotropy was introduced into the film plane by applying magnetic field of 100 Oe upon film forming.

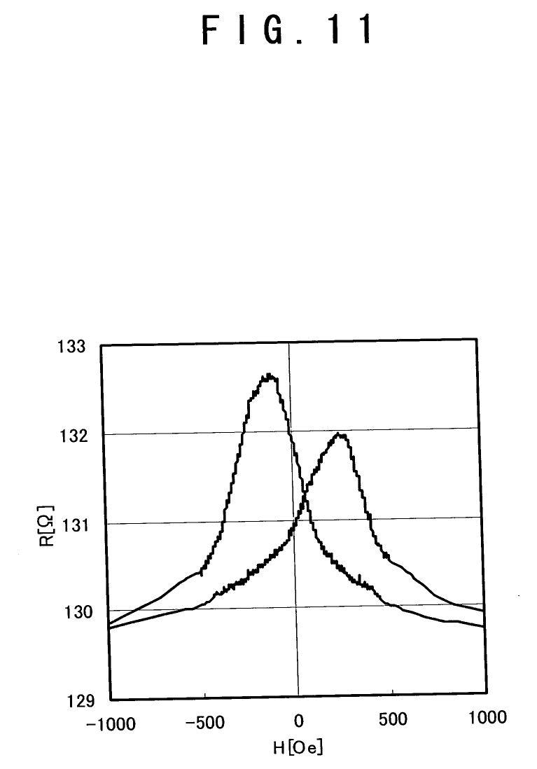

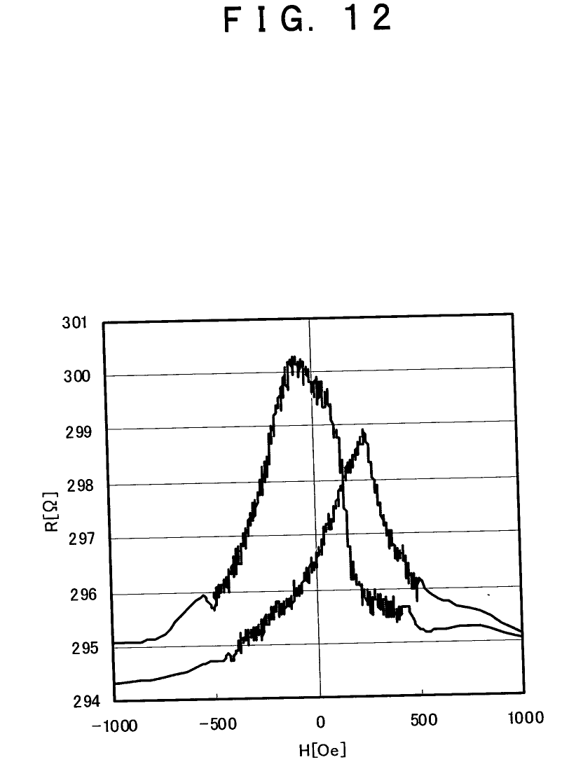

By applying the external magnetic field to said tunnel magnetoresistance effect device 15 having Co₂CrGa magnetic thin film of 300 nm film thickness, the magnetoresistance was measured at room temperature. FIG. 11 is a view illustrating the magnetic field dependency of the resistance of the tunnel magnetoresistance effect device 15 of Example 2. The abscissa of the figure shows the external magnetic field H (Oe), and the ordinate shows the resistance (Ω). The magnetoresistance including also its hysteresis characteristics was measured by sweeping the external magnetic field. Hereby, the TMR was determined as 2.6%.

### EXAMPLE 3

The tunnel magnetoresistance effect device 15 of the same spin valve type as Example 2 was fabricated by using Co₂CrGa thin film 3 except that its film thickness was 100 nm. By applying the external magnetic field to said tunnel magnetoresistance effect device 15, the magnetoresistance was measured at room temperature. FIG. 12 is a view illustrating the magnetic field dependency of the resistance of the tunnel magnetoresistance effect device 15 of Example 3. The abscissa of the figure shows the external magnetic field H (Oe), and the ordinate shows the resistance (Ω). The magnetoresistance including also its hysteresis characteristics was measured by sweeping the external magnetic field. Hereby, the TMR was determined as 3.2%.

In Examples 2 and 3, no plateau was seen in TMR curves, and the perfect antiparallel state of spins was not realized. By optimizing the fabrication conditions of the tunnel magnetoresistance effect device 15, a TMR will be made dramatically larger.

### INDUSTRIAL APPLICABILITY

In accordance with the present invention, Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film having L2₁ or B2 single phase structure can be fabricated at room temperature without heating. Further, it shows the ferromagnetic property and the high spin polarizability.

Also, with a giant magnetoresistance effect device using Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film having L2₁ or B2 single phase structure, the extremely large GMR can be attained at room temperature in low external magnetic field. Also with the tunnel magnetoresistance effect device, quite large TMR can be similarly attained.

Further by applying various magnetoresistance effect devices of the present invention using Co₂MGa₁₋ₓAlₓ (where M consists either of Mo, W, or Cr, or of two or more of Ti, V, Mo, W, Cr, Mn, and Fe, and an average valence electron concentration Z of M is 5.5≦Z≦7.5, and x is 0≦x≦0.7.) magnetic thin film having L2₁ or B₂ single phase structure to such various magnetic devices as the magnetic heads of super gigabit large capacity and high speed, or non-volatile and high speed MRAM and the like, novel magnetic devices can be realized. In this case, since the saturation magnetization is small, the magnetic switching field by spin injection becomes small, and magnetization reversal can be realized with low power consumption, as well as it is applicable as the key material to open widely the field of spin electronics, as efficient spin injection to semiconductors becomes possible, and development of spin FET is also possible.

1. A magnetic thin film, comprising: a substrate, and Co₂MGa₁₋ₓAlₓ thin film formed on said substrate, said Co₂MGa₁₋ₓAlₓ thin film has L2₁ or B₂ single phase structure, M of said thin film consists either of Mo, W, or Cr, or of two or more of Ti, V, Mo, W, Cr, Mn, and Fe, and
an average valence electron concentration Z in said M is 5.5≦Z≦7.5, and 0≦x≦0.7.

2. The magnetic thin film as set forth in claim 1, wherein said substrate is heated, and said Co₂MGa₁₋ₓAlₓ thin film is formed on said heated substrate.

3. The magnetic thin film as set forth in claim 1, wherein said Co₂MGa₁₋ₓAlₓ thin film formed on the substrate is annealed.

4. The magnetic thin film as set forth in claim 1, wherein said substrate is either one of thermally oxidized Si, glass, MgO single crystal, GaAs single crystal, and Al₂O₃ single crystal.

5. The magnetic thin film as set forth in claim 1, wherein a buffer layer is provided between said substrate and said Co₂MGa₁₋ₓAlₓ thin film.

6. The magnetic thin film as set forth in claim 5, wherein said buffer layer is made of at least either one of Al, Cu, Cr, Fe, Nb, Ni, Ta, and NiFe.

7. A tunnel magnetoresistance effect device, comprising:
a plurality of ferromagnetic layers on the substrate, at least one of the ferromagnetic layers is Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having either L2₁ or B2 single phase structure.

8. The tunnel magnetoresistance effect device as set forth in claim 7, wherein said ferromagnetic layer comprises a fixed layer and a free layer, and said free layer is Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having either L2₁ or B2 single phase structure.

9. The tunnel magnetoresistance effect device as set forth in claim 7, wherein said substrate is heated, and said Co₂MGa₁₋ₓAlₓ magnetic thin film is formed on said heated substrate.

10. The tunnel magnetoresistance effect device as set forth in claim 7, wherein said Co₂MGa₁₋ₓAlₓ magnetic thin film formed on the substrate is annealed.

11. The tunnel magnetoresistance effect device as set forth in claim 7, wherein said substrate is either one of thermally oxidized Si, glass, MgO single crystal, GaAs single crystal, and Al₂O₃ single crystal.

12. The tunnel magnetoresistance effect device as set forth in claim 7, wherein a buffer layer is provided between said substrate and said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7).

13. The tunnel magnetoresistance effect device as set forth in claim 12, wherein said buffer layer is made of at least either one of Al, Cu, Cr, Fe, Nb, Ni, Ta, and NiFe.

14. A giant magnetoresistance effect device, comprising a plurality of ferromagnetic layers on a substrate, at least one of the ferromagnetic layers is Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having L2₁ or B2 single phase structure, and has the structure in which electric current flows in the direction perpendicular to film surface.

15. The giant magnetoresistance effect device as set forth in claim 14, wherein said ferromagnetic layer comprises a fixed layer and a free layer, and said free layer is Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having either one of L2₁, B2, and A2 structures.

16. The giant magnetoresistance effect device as set forth in claim 14, wherein said substrate is heated, and said Co₂MGa₁₋ₓAlₓ magnetic thin film is formed on said heated substrate.

17. The giant magnetoresistance effect device as set forth in claim 14, wherein said Co₂MGa₁₋ₓAlₓ magnetic thin film formed on the substrate is annealed.

18. The giant magnetoresistance effect device as set forth in claim 14, wherein said substrate is either one of thermally oxidized Si, glass, MgO single crystal, GaAs single crystal, and Al₂O₃ single crystal.

19. The giant magnetoresistance effect device as set forth in claim 14, wherein a buffer layer is provided between said substrate and said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) thin film.

20. The giant magnetoresistance effect device as set forth in claim 19, wherein said buffer layer is made of at least either one of Al, Cu, Cr, Fe, Nb, Ni, Ta, and NiFe.

21. A magnetic device, comprising a Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having L2₁ or B2 single phase structure formed on a substrate.

22. The magnetic device as set forth in claim 21, wherein it uses a tunnel magnetoresistance effect device or a giant magnetoresistance effect device in which a free layer is said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film.

23. The magnetic device as set forth in claim 21, wherein it uses a tunnel magnetoresistance effect device or a giant magnetoresistance effect device fabricated by heating said substrate, and from said Co₂MGa₁₋ₓAlₓ magnetic thin film formed on said heated substrate.

24. The magnetic device as set forth in claim 21, wherein it uses a tunnel magnetoresistance effect device or a giant magnetoresistance effect device fabricated by annealed said Co₂MGa₁₋ₓAlₓ magnetic thin film formed on the substrate.

25. The magnetic device as set forth in claim 21, wherein it uses a tunnel magnetoresistance effect device or a giant magnetoresistance effect device in which said substrate is either one of thermally oxidized Si, glass, MgO single crystal, GaAs single crystal, and Al₂O₃ single crystal.

26. The magnetic device as set forth in claim 21, wherein it uses a tunnel magnetoresistance effect device or a giant magnetoresistance effect device in which a buffer layer is provided between said substrate and said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) thin film.

27. The magnetic device as set forth in claim 26, wherein it uses a tunnel magnetoresistance effect device or a giant magnetoresistance effect device in which said buffer layer is made of at least either one of Al, Cu, Cr, Fe, Nb, Ni, Ta, and NiFe.

28. A magnetic recording device, wherein it uses a magnetic head in which Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film having L2₁ or B2 single phase structure is formed on a substrate.

29. The magnetic recording device as set forth in claim 28, wherein it uses a tunnel magnetoresistance effect device or a giant magnetoresistance effect device in its magnetic head in which the free layer is said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) magnetic thin film.

30. The magnetic recording device as set forth in claim 28, wherein it uses in its magnetic head a tunnel magnetoresistance effect device or a giant magnetoresistance effect device fabricated by heating said substrate, and from said Co₂MGa₁₋ₓAlₓ magnetic thin film formed on said heated substrate.

31. The magnetic recording device as set forth in claim 28, wherein it uses in its magnetic head a tunnel magnetoresistance effect device or a giant magnetoresistance effect device fabricated by annealed said Co₂MGa₁₋ₓAlₓ magnetic thin film formed on the substrate.

32. The magnetic recording device as set forth in claim 28, wherein it uses a tunnel magnetoresistance effect device or a giant magnetoresistance effect device in its magnetic head in which said substrate is either one of thermally oxidized Si, glass, MgO single crystal, GaAs single crystal, and Al₂O₃ single crystal.

33. The magnetic recording device as set forth in claim 28, wherein it uses a tunnel magnetoresistance effect device or a giant magnetoresistance effect device in its magnetic head in which a buffer layer is provided between said substrate and said Co₂MGa₁₋ₓAlₓ (where M consists either of Mo, W, or Cr, or of two or more of Ti, V, Mo, W, Cr, Mn, and Fe, an average valence electron concentration Z in M is 5.5≦Z≦7.5, and 0≦x≦0.7) thin film.

34. The magnetic recording device as set forth in claim 33, wherein it uses a tunnel magnetoresistance effect device or a giant magnetoresistance effect device in its magnetic head in which said buffer layer is made of at least either one of Al, Cu, Cr, Fe, Nb, Ni, Ta, and NiFe.
